(19) United States
(12) Patent Application Publication
(10) Pub. No.: US 2016/0316953 A1
(43) Pub. Date: Nov. 3, 2016

(54) WINDOW TREATMENT SYSTEM

(71) Applicant: Steve Messri, Los Angeles, CA (US)

(72) Inventor: Steve Messri, Los Angeles, CA (US)

(21) Appl. No.: 14/698,821

(22) Filed: Apr. 28, 2015

(51) Int. Cl. A47H 19/00; A47H 1/18; E06B 7/28; F16M 13/02; E06B 7/00

(52) U.S. Cl. CPC A47H 19/00; F16M 13/02; E06B 7/00; E06B 7/28; A47H 1/18

(57) ABSTRACT

The embodiments herein provide a decorative custom window treatment accessory that allows a user to slip a drapery onto the window treatment easily and quickly. The accessory comprises an ornamental scroll for decorating a window and a wire with a plurality of bumps to securely hold a drapery. The wire comprises two washers located at both ends. Several studs are provided on the wire to hold the wire onto the scroll having two mounting brackets and two holes. Each bracket is located on either end of the scroll to affix the scroll to a wall. The first hole is configured for holding an extension arm and the mounting bracket, while the second hole is threaded for grasping the stud that holds the wire. A nut is placed on the stud to keep the washer of the wire to avoid a disconnection of the wire from the scroll.

### BACKGROUND

1. Technical Field

The embodiments herein are generally related to construction industry and technology. The embodiments herein are particularly related to window treatment methods and systems. The embodiments herein are particularly related to systems and methods for an ornamental window treatment. The embodiments herein are especially related to a system and method for customizing ornamental window treatment by a consumer in a do-it-by-yourself techniques.

2. Description of the Related Art

The beauty and luxury associated with the window treatment is largely a matter of how the unit is designed. An adequate customization with respect to the fabrics that are used, the layering of different colours and many other factors come into picture when designing a professional look for any interior space.

The present day window treatments are designed to be installed by a skilled craftsman. The window treatments are complex, expensive and difficult to install for the consumer themselves. When window treatments are expensive and difficult to install, the consumer are deprived with an ability to create exquisite dressings for the windows.

To overcome the aforementioned drawbacks, there is a need for a window treatment which is installed by the consumer, without any need of the skilled craftsman. Further there is a need for a system and method to customize an ornamental window treatment process by employing a do-it-by-yourself techniques. Still further there is a need for a system and method to customize an ornamental window treatment process without requiring any skilled manpower or specialized skills or techniques. Yet there is a need for a system and method to customize an ornamental window treatment process to provide a professional look for any interior space.

The above mentioned shortcomings, disadvantages and problems are addressed herein and which will be understood by reading and studying the following specification.

### OBJECTS OF THE EMBODIMENTS HEREIN

The primary object of the embodiments herein is to provide a system and method to customize an ornamental window treatment process by adopting a do-it-yourself techniques to allow a user to slip a drape of curtains onto the window treatment easily and quickly.

Another object of the embodiments herein is to provide a system and method to customize an ornamental window treatment process to enable interior designers or owners of homes to design and install customized window treatments easily and quickly by using a do-it-by-yourself techniques.

Yet another object of the embodiments herein is to provide a system and method to customize an ornamental window treatment process with swags, valances, jabots, cascades and side panels which are easily designed and installed.

Yet another object of the embodiments herein is to provide a system and method to customize an ornamental window treatment process to enable the consumers to customize the window dressings easily and efficiently by using a do-it-by-your self techniques.

Yet another object of the embodiment herein is to provide to provide a system and method to customize an ornamental window treatment process to properly hold the drapery material in a professional manner to provide a luxurious look for any window dressing.

Yet another object of the embodiments herein is to provide a system and method to customize an ornamental window treatment process to transform a purely decorative window treatment into a functional item without having to invest in an additional hardware or labor to hang drapes.

Yet another object of the embodiments herein is to provide a system and method to customize an ornamental window treatment process with respect the fabrics that are used, the plurality of multi-colored layers and several other factors to provide a colourful and professional look to any interior space.

Yet another object of the embodiments herein is to provide a system and method to customize an ornamental window treatment process to create a new way to design and install custom window treatments for the interior design industry and consumer.

Yet another object of the embodiments herein is to provide a system and method to customize an ornamental window treatment process to provide a draping mechanism to be mounted on existing rods.

Yet another object of the embodiments herein is to provide a system and method to customize an ornamental window treatment process to provide a draping mechanism to be mounted on top of currently existing straight curtain rods, blinds, shades as well as these are mounted on top of a cornice box.

Yet another object of the embodiments herein is to provide a system and method to customize an ornamental window treatment process to provide a draping mechanism to combine a traditional drapery hardware scroll and a flexible under wire to support a drapery fabric that conforms to a shape of the scroll in a unique and innovative manner.

Yet another object of the embodiments herein is to provide a system and method to customize an ornamental window treatment process to add multiple wires on the scroll to provide support for multiple layers including scarf swags, cascades, valances, jabots, and side panels.

Yet another object of the embodiments herein is to provide a system and method to customize an ornamental window treatment process to enable or allow the window treatments to be installed nearly flush to the side walls, a feat that could not be accomplished with standard poles and finials.

These and other objects and advantages of the embodiments herein will become readily apparent from the following summary and the detailed description taken in conjunction with the accompanying drawings.

### SUMMARY

The various embodiments herein provide a system and method to customize an ornamental window treatment process by adopting a do-it-yourself techniques to allow a user to slip a drape of curtains onto the window treatment easily and quickly. The embodiments herein provide a decorative window treatment accessory. The accessory comprises an ornamental scroll used for decorating a window and a wire to securely hold a drapery. The wire further comprises at least two washers. One washer is provided at both the ends of the wire. The accessory further comprises a plurality of studs configured to hold the wire onto the scroll and a plurality of bumps that are provided on the wire.

According to an embodiment herein, the wire is attached to a back of the scroll by inserting the washers at both ends of the wire onto the studs mounted on the scroll.

According to an embodiment herein, the wire is curved to the follow the shape of the scroll.

According to an embodiment herein, the accessory further comprises at least two mounting brackets. One bracket is located on either end of the scroll. The scroll is affixed to a wall using the mounting brackets.

According to an embodiment herein, the accessory comprises at least two holes on each end of the scroll. The first hole is configured for holding an extension arm and the mounting bracket. The second hole is threaded for grasping or receiving and holing the stud that holds the wire.

According to an embodiment herein, a nut is placed on the stud to keep and hold the washer of the wire to the scroll to avoid a disconnection of the wire from the scroll.

According to an embodiment herein, the extension screw is inserted into the first hole. A sleeve of the curtain drapes is placed over the extension screw and is secured by a second screw on the side of the sleeve.

According to an embodiment herein, the bumps on the wire are used or configured for holding the drapery in place and for avoiding the movement of the drapery. The bumps are raised metal projections along the length of the scroll wire that grip the fabric to prevent a slippage of the fabric due to the prolonged effects of gravity. Smooth wires provide no friction to keep the fabric in place and properly dressed. The bumps on the wire provide a resistance necessary to keep the fabric firmly in place thereby maintaining the integrity of the drapery design.

According to an embodiment herein, the mounting brackets are extendable to a plurality of projection lengths. The mounting brackets are affixed to the back of the scroll and are extendable to different projection lengths that allows other layers of window treatments to be placed under them. This arrangement can also be mounted on top of currently existing straight curtain rods, blinds, shades as well as they can be mounted on top of a cornice box.

According to an embodiment herein, the fabric ends are not fixed to the mounting brackets. The fabric is sewn with a pocket along the top-most edge which is used to house the wire once it/the wire is sleeved into the pocket. In some instances, where additional light prevention is needed, a splice is cut 2-3 inches from the end of the fabric and the scroll wire is threaded out of the splice. The end tip of the splice is then attached to a mounting screw which is affixed to the wall.

According to an embodiment herein, the accessory is a do-it-yourself custom window treatment accessory. The combination of a traditional drapery hardware scroll and a flexible under wire to support the drapery fabric that conforms to the shape of the scroll is a unique and innovative concept. The addition of multiple wires on the scroll can provide support for multiple layers including scarf swags, cascades, valances, jabots, and side panels.

According to an embodiment herein, a system and method is provided to customize an ornamental window treatment process by adopting a do-it-yourself techniques to allow a user to slip a drape of curtains onto the window treatment easily and quickly. The embodiments herein are related to custom window treatments, specifically custom window treatments that are designed to be installed by consumers rather than skilled craftsman.

According to an embodiment herein, the embodiments herein provide adequate customization with respect to the fabrics that are used, the layering of different colors and many other factors all come into play when designing a professional look for any interior space.

According to an embodiment herein, an improved luxury do-it yourself custom window treatment has a rod that is affixed to the back of the hardware that allows users to slip the sleeve of the drape onto the rod easily and quickly. These rods screw back into place after the drapery material is properly affixed to create a professional and luxurious look for any window dressing.

According to an embodiment herein, the combination of traditional drapery scrolls with the wire on the back transforms a purely decorative window treatment into a functional item without having to invest in additional hardware or labor to hang drapes. This transformation saves the homeowner or designer with time, money and creates professional level results much simpler.

According to an embodiment herein, a method for customizing an ornamental window is provided. The method comprises the steps of selecting a traditional drapery scrolls; providing wires at the back of the scrolls and wherein a plurality of bumps are provided on the wire; affixing a plurality of mounting brackets to a back of the scroll; and inserting fabrics into the wires. The plurality of bumps are configured to provide resistance to the inserted fabrics to keep the inserted fabrics firmly in place thereby maintaining an integrity of the drapery design.

According to an embodiment herein, the wire is attached to a back of the scroll by inserting washers at both ends of the wire onto a plurality of studs mounted on the scroll.

According to an embodiment herein, the wire is curved to follow a shape of the scroll.

According to an embodiment herein, each mounting bracket is located on either end of the scroll and the scroll is affixed to a wall using the mounting brackets.

According to an embodiment herein, the method further comprises providing at least two holes on each end of the scroll. The first hole is configured for holding an extension arm and the mounting bracket. The second hole is threaded for grasping the stud that holds the wire.

According to an embodiment herein, the method further comprises arranging a nut on the stud to keep the washer of the wire in place to avoid a disconnection of the wire from the scroll.

According to an embodiment herein, the method further comprises inserting an extension screw into the first hole.

According to an embodiment herein, the method further comprises placing a sleeve of curtain drapes over the extension screw and wherein the drapes is secured by a second screw on the side of the sleeve.

According to an embodiment herein, the bumps on the wire are configured for holding the drapery in place and for avoiding a movement of the drapery.

According to an embodiment herein, the mounting brackets are extendable to a plurality of projection lengths.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a front view of a scroll used in a window treatment accessory in a system and method for customizing an ornamental window treatment process, according to an embodiment herein.

FIG. 2 illustrates a back view of the scroll used in the window treatment accessory in a system and method for customizing an ornamental window treatment process, according to an embodiment herein.

FIG. 3 illustrates a back view of the scroll with a wire for holding a drapery, in a system and method for customizing an ornamental window treatment process, according to an embodiment herein.

FIG. 4 illustrates an enlarged view of a draping accessory or mechanism provided at the back of the scroll, in a system and method for customizing an ornamental window treatment process, according to an embodiment herein.

FIG. 5 illustrates a perspective view of the scroll, in a system and method to customize an ornamental window treatment process, according to an embodiment herein.

FIG. 6 illustrates a perspective view of the scroll with mounting brackets, in a system and method to customize an ornamental window treatment process, according to an embodiment herein.

FIG. 7 illustrates a perspective view of the wire, in a draping mechanism in a system and method to customize an ornamental window treatment process, according to an embodiment herein.

FIG. 8 illustrates a partially enlarged view of the wire, in a draping mechanism in a system and method to customize an ornamental window treatment process, according to an embodiment herein.

FIG. 9 illustrates a perspective view of the window treated with a draping mechanism in a system and method to customize an ornamental window treatment process, according to an embodiment herein.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### DETAILED DESCRIPTION OF THE EMBODIMENTS HEREIN

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a system and method to customize an ornamental window treatment process by adopting a do-it-yourself techniques to allow a user to slip a drape of curtains onto the window treatment easily and quickly. The embodiments herein provide a decorative window treatment accessory. The accessory comprises an ornamental scroll used for decorating a window and a wire to securely hold a drapery. The wire further comprises at least two washers. One washer is provided at both the ends of the wire. The accessory further comprises a plurality of studs configured to hold the wire onto the scroll and a plurality of bumps that are provided on the wire.

According to an embodiment herein, the wire is attached to a back of the scroll by inserting the washers at both ends of the wire onto the studs mounted on the scroll.

According to an embodiment herein, the wire is curved to the follow the shape of the scroll.

According to an embodiment herein, the accessory further comprises at least two mounting brackets. One bracket is located on either end of the scroll. The scroll is affixed to a wall using the mounting brackets.

According to an embodiment herein, the accessory comprises at least two holes on each end of the scroll. The first hole is configured for holding an extension arm and the mounting bracket. The second hole is threaded for grasping or receiving and holing the stud that holds the wire.

According to an embodiment herein, a nut is placed on the stud to keep and hold the washer of the wire to the scroll to avoid a disconnection of the wire from the scroll.

According to an embodiment herein, the extension screw is inserted into the first hole. A sleeve of the curtain drapes is placed over the extension screw and is secured by a second screw on the side of the sleeve.

According to an embodiment herein, the bumps on the wire are used or configured for holding the drapery in place and for avoiding the movement of the drapery. The bumps are raised metal projections along the length of the scroll wire that grip the fabric to prevent a slippage of the fabric due to the prolonged effects of gravity. Smooth wires provide no friction to keep the fabric in place and properly dressed. The bumps on the wire provide a resistance necessary to keep the fabric firmly in place thereby maintaining the integrity of the drapery design.

According to an embodiment herein, the mounting brackets are extendable to a plurality of projection lengths. The mounting brackets are affixed to the back of the scroll and are extendable to different projection lengths that allows other layers of window treatments to be placed under them. This arrangement can also be mounted on top of currently existing straight curtain rods, blinds, shades as well as they can be mounted on top of a cornice box.

According to an embodiment herein, the fabric ends are not fixed to the mounting brackets. The fabric is sewn with a pocket along the top-most edge which is used to house the wire once it/the wire is sleeved into the pocket. In some instances, where additional light prevention is needed, a splice is cut 2-3 inches from the end of the fabric and the scroll wire is threaded out of the splice. The end tip of the splice is then attached to a mounting screw which is affixed to the wall.

According to an embodiment herein, the accessory is a do-it-yourself custom window treatment accessory. The combination of a traditional drapery hardware scroll and a flexible under wire to support the drapery fabric that conforms to the shape of the scroll is a unique and innovative concept. The addition of multiple wires on the scroll can provide support for multiple layers including scarf swags, cascades, valances, jabots, and side panels.

According to an embodiment herein, a system and method is provided to customize an ornamental window treatment process by adopting a do-it-yourself techniques to allow a user to slip a drape of curtains onto the window treatment easily and quickly. The embodiments herein are related to custom window treatments, specifically custom window treatments that are designed to be installed by consumers rather than skilled craftsman.

According to an embodiment herein, the embodiments herein provide adequate customization with respect to the fabrics that are used, the layering of different colors and many other factors all come into play when designing a professional look for any interior space.

According to an embodiment herein, an improved luxury do-it yourself custom window treatment has a rod that is affixed to the back of the hardware that allows users to slip the sleeve of the drape onto the rod easily and quickly. These rods screw back into place after the drapery material is properly affixed to create a professional and luxurious look for any window dressing.

According to an embodiment herein, the combination of traditional drapery scrolls with the wire on the back transforms a purely decorative window treatment into a functional item without having to invest in additional hardware or labor to hang drapes. This transformation saves the homeowner or designer with time, money and creates professional level results much simpler.

The various embodiments herein provide a decorative window treatment accessory. The accessory is a custom window treatment that allows a user to slip a drapery onto the window treatment easily and quickly. The accessory comprises an ornamental scroll used for decorating a window and a wire to securely hold a drapery. The wire further comprises at least two washers, each at both ends of the wire. The accessory further comprises a plurality of studs configured to hold the wire onto the scroll and a plurality of bumps on the wire.

According to an embodiment herein, a method for customizing an ornamental window is provided. The method comprises the steps of selecting a traditional drapery scrolls; providing wires at the back of the scrolls and wherein a plurality of bumps are provided on the wire; affixing a plurality of mounting brackets to a back of the scroll; and inserting fabrics into the wires. The plurality of bumps are configured to provide resistance to the inserted fabrics to keep the inserted fabrics firmly in place thereby maintaining an integrity of the drapery design.

According to an embodiment herein, the wire is attached to a back of the scroll by inserting washers at both ends of the wire onto a plurality of studs mounted on the scroll.

According to an embodiment herein, the wire is curved to follow a shape of the scroll.

According to an embodiment herein, each mounting bracket is located on either end of the scroll and the scroll is affixed to a wall using the mounting brackets.

According to an embodiment herein, the method further comprises providing at least two holes on each end of the scroll. The first hole is configured for holding an extension arm and the mounting bracket. The second hole is threaded for grasping the stud that holds the wire.

According to an embodiment herein, the method further comprises arranging a nut on the stud to keep the washer of the wire in place to avoid a disconnection of the wire from the scroll.

According to an embodiment herein, the method further comprises inserting an extension screw into the first hole.

According to an embodiment herein, the method further comprises placing a sleeve of curtain drapes over the extension screw and wherein the drapes is secured by a second screw on the side of the sleeve.

According to an embodiment herein, the bumps on the wire are configured for holding the drapery in place and for avoiding a movement of the drapery.

According to an embodiment herein, the mounting brackets are extendable to a plurality of projection lengths.

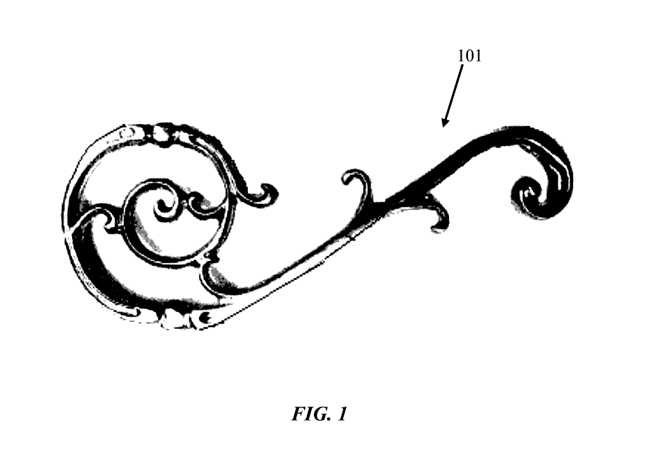

FIG. 1 illustrates a top view of a scroll used in a window treatment accessory, according to an embodiment herein. The view, as shown in the FIG. 1, is the part that is visible to the user after the accessory is installed. The scroll 101 is an ornamental part used for decorating the window treatment. The scroll 101 is used by the user to hold the drapery in place for creating exquisite dressings for the windows.

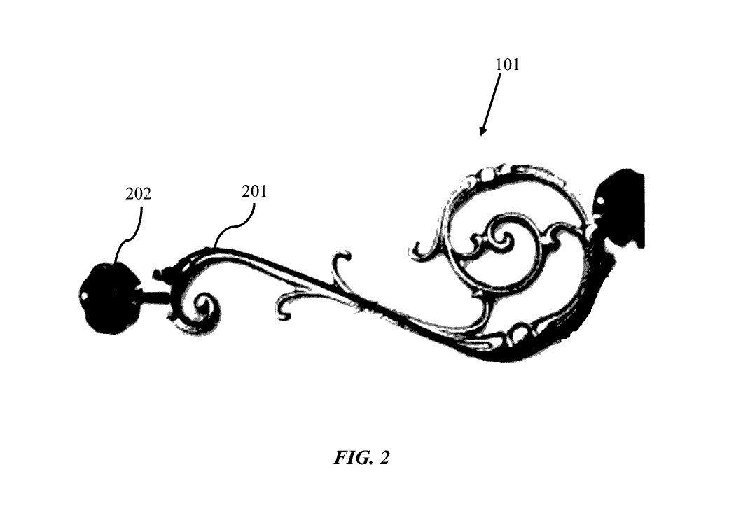

FIG. 2 illustrates a back view of the scroll used in the window treatment accessory, according to an embodiment herein. Referring to FIG. 2, the window treatment has the wire 201 that is affixed to the scroll 101. The user is entitled to slip the drapery onto the wire 201 for creating a required window dressing by the user. The user fastens back the wire into place, after the drapery is properly hung from the scroll. The scroll further comprises at least two mounting brackets 202 for attaching the decorative window treatment along with the hanging drapery onto a wall.

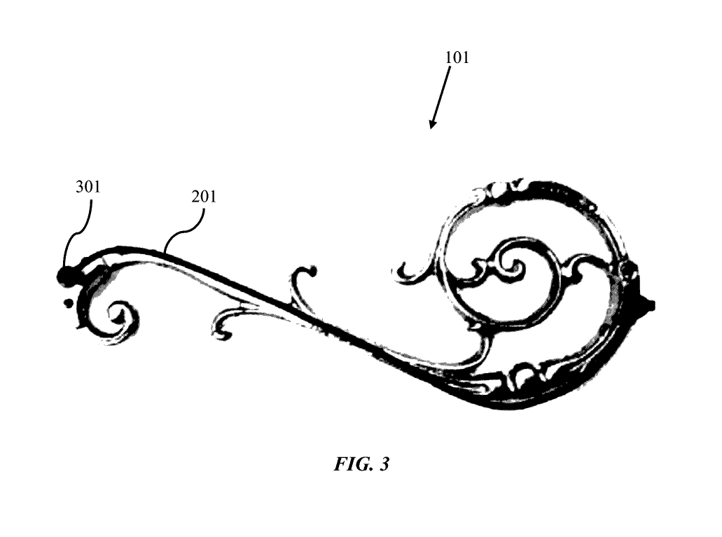

FIG. 3 illustrates a back view of the scroll with a wire for holding the drapery, according to an embodiment herein. The wire 201 is curved to the follow the shape of the scroll. The wire 201 is held to the scroll 101 with a help of the washers and studs 301 present on both the ends of the wire 201 and the scroll 101 respectively.

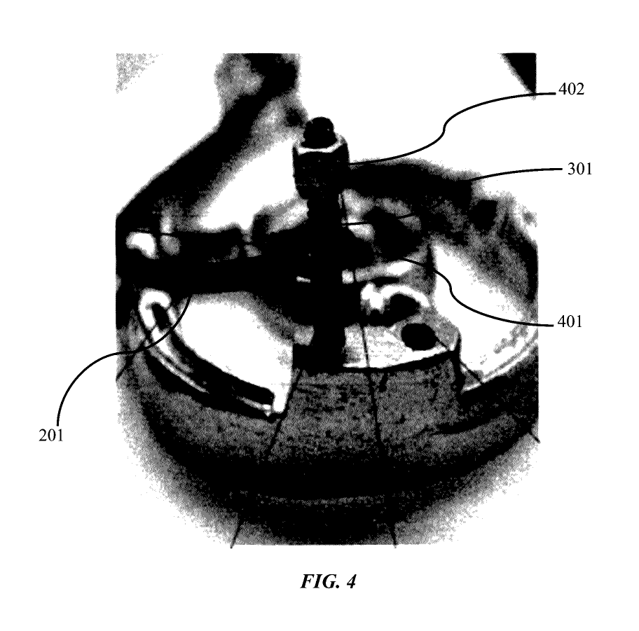

FIG. 4 illustrates a close-up view taken from the back of the scroll, according to an embodiment herein. The studs 301 are long screwed rod with threads extending along the complete length of the rod. The washer 401 is a thin plate with a hole (typically in the middle) connected on both the ends of the wire 201. The inner diameter of the washer 401 is slightly larger than the outer diameter of the stud 301. The washer 401 is inserted onto the stud 301 and a nut 402 is placed on the stud 301 and threaded to the stud 301 to avoid the washer/wire from coming off the stud 301.

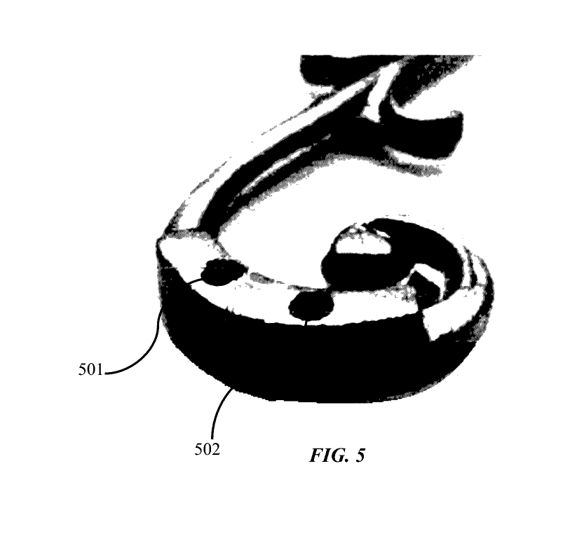

FIG. 5 illustrates a perspective view of the scroll, according to an embodiment herein. The scroll 101 comprises at least two holes 501, 502, with each hole drilled on the two ends of the scroll. The inner surfaces of the holes 501 are threaded and the studs are screwed into the two holes of the scroll. The scroll comprises another pair of holes 502, each hole on either end of the scroll. The holes 502 are configured to hold the mounting brackets onto the scroll. The bracket mounting hole 502 used for holding mounting bracket and stud hole 501 are separated by a particular or preset distance, preferably 1 inch.

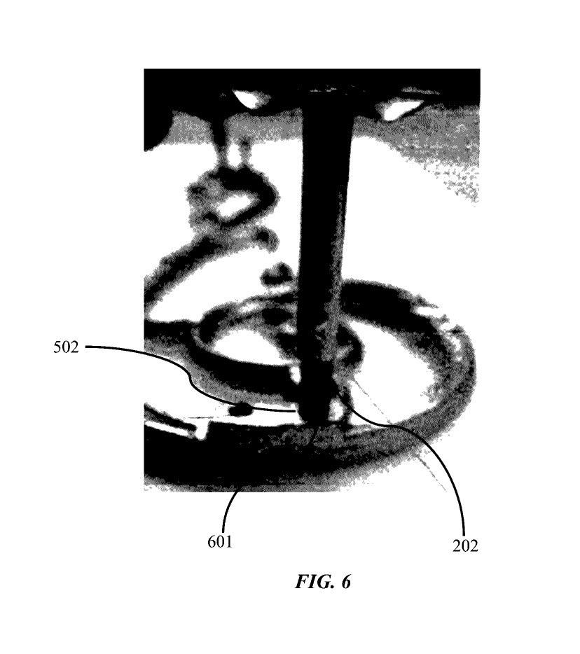

FIG. 6 illustrates a perspective view of the scroll with mounting brackets, according to an embodiment herein. The holes 502 are threaded for screwing an extension arm 601 in each hole, wherein the mounting bracket 202 is fixed on the extension arm 601. The extension screw 601 is inserted into the hole 502 and a sleeve of the drapery is placed over the extension screw 601. The sleeve is secured by a second screw which is inserted on a side of the sleeve.

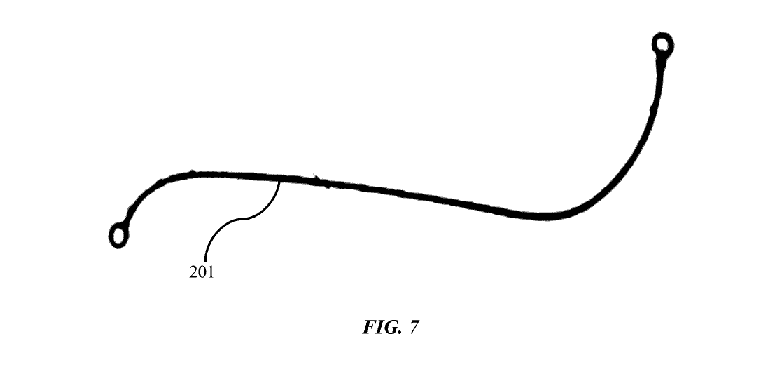

FIG. 7 illustrates a perspective view of the wire, according to an embodiment herein. The wire 201 is a flexible under wire to support the drapery. The wire 201 conforms to the shape of the scroll. The addition of multiple wires on the scroll provides support for multiple layers including, but not limited to, scarf swags, cascades, valances, jabots, and side panels.

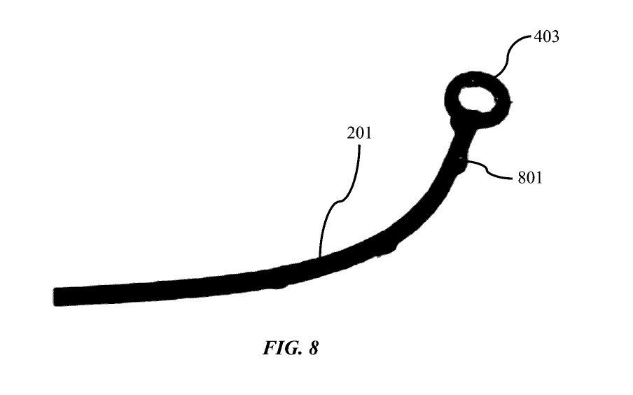

FIG. 8 illustrates a close-up view of the wire, according to an embodiment herein. The bumps 801 on the wire 201 hold the drapery fabric in place and avoids slipping of the drapery. The washer 403 at the end of the wire 201 slips over the stud and holds it in place. Smooth wires provide no friction to keep fabric in place and properly dressed. The bumps 801 on the wire 201 provide the necessary resistance to keep the fabric firmly in place thereby maintaining the integrity of the drapery design. the bumps on the wire are used or configured for holding the drapery in place and for avoiding the movement of the drapery. The bumps are raised metal projections along the length of the scroll wire that grip the fabric to prevent a slippage of the fabric due to the prolonged effects of gravity. Smooth wires provide no friction to keep the fabric in place and properly dressed. The bumps on the wire provide a resistance necessary to keep the fabric firmly in place thereby maintaining the integrity of the drapery design.

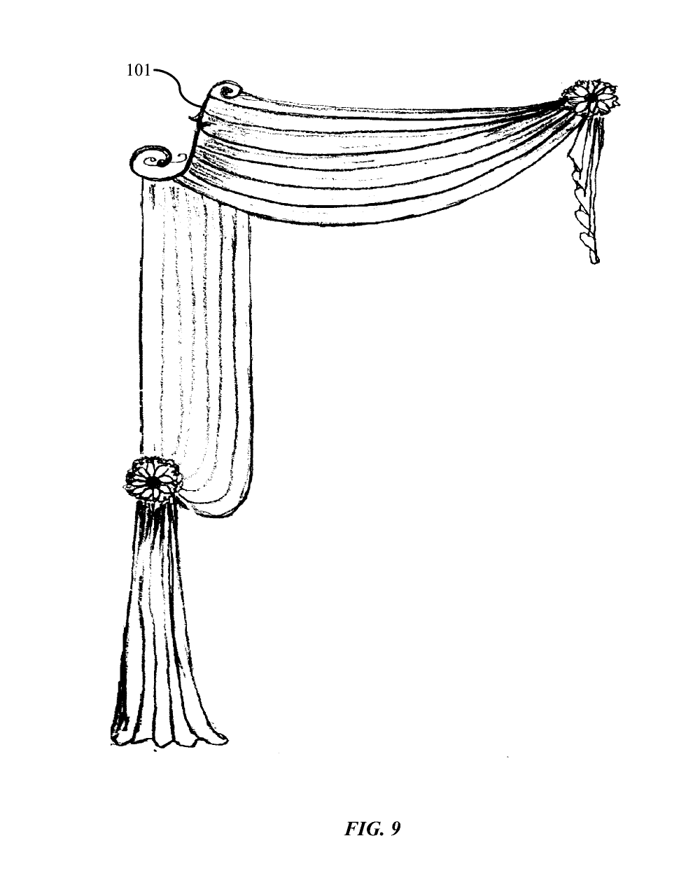

FIG. 9 illustrates a perspective view of the window treatment, according to an embodiment herein. The mounting brackets are affixed to the back of the scroll 101 and are extendable to different projection lengths that allows multiple layers of window treatments to be placed under the brackets. The accessory 101 is mounted on top of currently existing straight curtain rods, blinds, shades and the like, as well as they are mounted on top of a cornice box.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. A window treatment accessory comprising:
an ornamental scroll used for decorating a window;
a wire to securely hold a drapery;
at least two washers, wherein each washer is provided at both ends of the wire;
a plurality of studs configured to hold the wire onto the scroll; and
a plurality of bumps on the wire.

2. The accessory according to claim 1, wherein the wire is attached on a back of the scroll by inserting the washers at both ends of the wire onto the studs mounted on the scroll.

3. The accessory according to claim 1, wherein the wire is curved to follow a shape of the scroll.

4. The accessory according to claim 1, further comprises at least two mounting brackets, and wherein each mounting bracket is located on either end of the scroll, or wherein the scroll is affixed to a wall using the mounting brackets.

5. The accessory according to claim 1, comprises at least two holes on each end of the scroll, and wherein the first hole is configured for holding an extension arm and the mounting bracket, and wherein the second hole is threaded for grasping the stud that holds the wire.

6. The accessory according to claim 1, wherein a nut is placed on the stud to keep the washer of the wire to avoid a disconnection of the wire from the scroll.

7. The accessory according to claim 1, wherein the extension screw is inserted into the first hole, and wherein a sleeve of the curtain drapes is placed over the extension screw and is secured by a second screw on the side of the sleeve.

8. The accessory according to claim 1, wherein the bumps on the wire are configured for holding the drapery in place and for avoiding the movement of the drapery.

9. The accessory according to claim 1, wherein the mounting brackets are extendable to a plurality of projection lengths.

10. The accessory according to claim 1, wherein the accessory is a do-it-yourself custom window treatment accessory.

11. A method for customizing an ornamental window, the method comprises:
selecting a traditional drapery scrolls;
providing wires at the back of the scrolls and wherein a plurality of bumps are provided on the wire;
affixing a plurality of mounting brackets to a back of the scroll;
inserting fabrics into the wires, and wherein the plurality of bumps provide resistance to the inserted fabrics to keep the inserted fabrics firmly in place thereby maintaining an integrity of the drapery design.

12. The method according to claim 11, wherein the wire is attached to a back of the scroll by inserting washers at both ends of the wire onto a plurality of studs mounted on the scroll.

13. The method according to claim 11, wherein the wire is curved to follow a shape of the scroll.

14. The method according to claim 11, wherein each mounting bracket is located on either end of the scroll, and wherein the scroll is affixed to a wall using the mounting brackets.

15. The method according to claim 11 further comprises providing at least two holes on each end of the scroll, and wherein the first hole is configured for holding an extension arm and the mounting bracket, wherein the second hole is threaded for grasping the stud that holds the wire.

16. The method according to claim 11 further comprises arranging a nut on the stud to keep the washer of the wire in place to avoid a disconnection of the wire from the scroll.

17. The method according to claim 11 further comprises inserting an extension screw into the first hole.

18. The method according to claim 11 further comprises placing a sleeve of curtain drapes over the extension screw and wherein the drapes is secured by a second screw on the side of the sleeve.

19. The method according to claim 11, wherein the bumps on the wire are configured for holding the drapery in place and for avoiding a movement of the drapery.

20. The method according to claim 11, wherein the mounting brackets are extendable to a plurality of projection lengths.
